(19) United States
(12) Patent Application Publication
(10) Pub. No.: US 2003/0045636 A1
(43) Pub. Date: Mar. 6, 2003

(54) Polyurethane compositions on the basis of polyester-polyether copolymers

(76) Inventors: Michael Krebs, Hilden (DE); Christoph Lohr, Wuppertal (DE); Andreas Brenger, Duesseldorf (DE)

Correspondence Address: HENKEL CORPORATION, 2500 RENAISSANCE BLVD, STE 200, GULPH MILLS, PA, 19406, US

(21) Appl. No.: 10/168,610

(22) PCT Filed: Dec. 13, 2000
(86) PCT No.: PCT/EP00/12659

(30) Foreign Application Priority Data
Dec. 22, 1999 (DE) 199 61 941.7

(51) Int. Cl. C08F 8/30; C08F 8/00; C08L 75/00; C08L 27/00

(52) U.S. Cl. 525/127; 525/129; 525/131

(57) ABSTRACT

The invention relates to compositions containing conversion products of a polyisocyanate with a polyester-polyether copolymer and a method for producing the same. Said compositions are suitable as a humidity-hardening hot-melt-type adhesive. The hot-melt-type adhesive composition can optionally also contain a conversion product of a polyisocyanate with a polyesterpolyol and/or a conversion product of a polyisocyanate with a polyetherpolyol. Such polyurethane hot-melt-type adhesive compositions are provided with good creep property and interfacial bonding values on synthetic materials and very high solidity values.

This invention relates to compositions containing reaction products of a polyisocyanate with a polyester/polyether copolymer, to their use as hotmelt adhesives and to a process for their production.

Reaction products of a stoichiometric excess of polyisocyanates with polyols—so-called polyurethane prepolymers with terminal isocyanate groups—are used for a number of applications, for example as sealants, coating materials or adhesives. Where these compositions are solid at room temperature and can be melted by heat in the absence of moisture, they may be used as reactive hotmelt adhesives. Accordingly, reactive one-component polyurethane hotmelt adhesives in the context of the present invention are moisture-curing or moisture-crosslinking adhesives which are solid at room temperature, which are applied in the form of a melt as the adhesive and of which the polymeric constituents contain urethane groups and reactive isocyanate groups. Under the cooling effect of its application to the substrate, coupled with the additional cooling effect of the substrate parts, the hotmelt adhesive initially undergoes rapid physical setting by solidification followed by a chemical reaction of the isocyanate groups still present with moisture from the surrounding atmosphere to form a crosslinked infusible adhesive.

Reactive hotmelt adhesives based on isocyanate-terminated polyurethane prepolymers are known in principle. Thus, in “Shaping Reactive Hotmelts Using LMW Copolyesters”, Adhesives Age, November 1987, pages 32 to 35, H. F. Huber and H. Müller describe the combination of isocyanate-terminated amorphous and crystalline polyesters which are said to have good adhesion to a variety of substrates. Formulations containing isocyanate-terminated polyester/polyether copolymers are not disclosed.

EP-A-340906 describes polyurethane hotmelt adhesive compositions containing a mixture of at least two amorphous polyurethane prepolymers which are characterized in that the prepolymers have different glass transition temperatures. Such mixtures of two prepolymers are said to improve the properties of the adhesive to the extent that they set quickly, are still flexible immediately after setting and show good thermal stability after curing.

DE-A-3827224 describes quick-setting, moisture-curing hotmelt adhesives of reaction products of polyisocyanates and hydroxypolyesters. The hydroxypolyesters are purely aliphatic and contain at least 12 methylene groups in the polyester unit of diol and dicarboxylic acid. Ether diols, i.e. oligomers or polymers based on ethylene glycol or butane-1,4-diol, may also be present although this is not preferred.

EP-A-455400 describes a mixture of isocyanate-terminated polyurethane prepolymers which consists essentially of a first crystalline prepolymer based on polyhexamethylene adipate and a second prepolymer based on polytetramethylene ether glycol. The compositions in question are said to have very good adhesion to a number of surfaces.

EP-A-568607 describes a mixture of isocyanate-terminated polyurethane prepolymers containing a first prepolymer based on the reaction product of an at least partly crystalline polyester polyol and a polyisocyanate and a second prepolymer based on the reaction product of a poly(tetramethylene ether)glycol and a polyisocyanate and a third prepolymer based on the reaction product of an amorphous polyester polyol and a polyisocyanate. The amorphous polyester polyol for the third prepolymer is said—in a preferred embodiment—to be made up at least partly of aromatic structural units. In order to improve the cohesive strength of the hotmelt adhesives, the molecular weight, more particularly of the glass-like polyester polyol, is said to be high. However, this results in extremely high-viscosity polymers which are difficult to mix and difficult to apply at the processing temperature. The hotmelt adhesives in question are said to be particularly suitable for bonding polymeric substrates, such as polystyrene or polymethyl methacrylate.

WO 91/15530 describes moisture-curing polyurethane hotmelt adhesives which combine the properties of thermoplastic hotmelt adhesives and reactive adhesives. Mixtures of a thermoplastic elastomer based on a polyester/polyether copolymer and a polyisocyanate prepolymer are described. The thermoplastic elastomer is said to be a segmented thermoplastic elastomer with hard and soft segments while the polyisocyanate prepolymer is said to be the reaction product of a polyol with a polyfunctional isocyanate having an isocyanate functionality of 2 or more. A preferred polyol for the polyurethane prepolymer is (poly(tetramethylene-ether)glycol. The adhesives in question are said to be suitable for the bonding of glass, metals and a number of plastics.

Despite the extensive prior art, there is a still a need for improved polyurethane compositions which are suitable for use as hotmelt adhesives. In particular, the raw materials used for the hotmelt adhesives should be readily and inexpensively available. Better compatibility of the individual polymer components is desirable for problem-free application. In addition, the hotmelt adhesives should have a broad adhesion spectrum to a number of substrates and a high strength level after curing.

The solution to this problem as provided by the invention is defined in the claims and consists essentially in the provision of a polyurethane composition for use in hotmelt adhesives containing

a reaction product of a polyisocyanate with a polyester/polyether copolymer corresponding to formula (I) or (II):

HO—R²—[—O-A-O—R¹—]ₙ—OH (I)

HO—R³—B-E-B—R³—OH (II)

where

A stands for

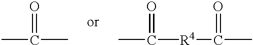

R¹ and R² independently of one another represent —(CH₂)ₘ—, (—(CH₂)₄—O—(CH₂)₄—)ₒ, (C₃H₆—O—C₃H₆—)ₒ, (—C₂H₄—O—C₂H₄—)ₚ or a combination thereof and

R³ represents —(CH₂)ₘ—, —(C₂H₄—O—C₂H₄)ₒ— or —(C₃H—O—C₃H₆)ₒ—,

B is the block of a carboxyl-terminated polyester or B and R³ together form the residue of a polycaprolactone,

E is the block of a poly(oxytetramethylene)glycol, poly(oxypropylene)glycol,poly(oxyethylene)glycol or copolymers thereof,

R⁴ is a C₁₋₁₂ alkyl group or a residue of a carboxyl-terminated polyester after removal of the carboxyl groups and n=1 to 30, m=2 to 12, o=5 to 80 and p=5 to 80.

In the most simple case, the polyester/ether copolymer in formula (I) consists of the synthesis components of an aliphatic or aromatic dicarboxylic acid containing 3 to 14 carbon atoms and a poly(oxytetramethylene)glycol, polypropylene glycol, polyethylene glycol or copolymers of ethylene oxide and propylene oxide. However, A is preferably the residue of a carboxyl-terminated polyester synthesized from aliphatic and/or aromatic dicarboxylic acids and dihydric alcohols. Preferred examples of aliphatic and aromatic dicarboxylic acids are adipic acid, pimelic acid, suberic acid, azelaic acid, sebacic acid, undecanedioic acid, dodecanedioic acid, phthalic acid, terephthalic acid, isophthalic acid or mixtures thereof. Preferred examples of dihydric alcohols are ethylene glycol, propylene glycol, butanediol, diethylene glycol, triethylene glycol, dipropylene glycol, tripropylene glycol, hexanediol, octanediol, decanediol, dodecanediol or mixtures thereof.

In another embodiment, block A may also be a carbonyl group, i.e. the ester component is the carbonic acid ester of a poly(oxytetramethylene)glycol, poly(oxypropylene)glycol or poly(oxyethylene)glycol.

Particularly preferred carboxyl-terminated polyester structural elements are polyester structural elements of adipic acid, sebacic acid or dodecanedioic acid and 1,6-hexanediol, 1,8-octanediol, 1,10-decanediol or 1,12-dodecanediol. The polyester block may have a molecular weight of 600 to 6,000 and preferably in the range from 1,000 to 4,000. The block of the poly(oxytetramethylene)glycol, also known as polytetrahydrofuran (poly-THF), may have a molecular weight in the range from 250 to 6,000 and preferably in the range from 600 to 4,000. If the polyether block consists of poly(oxypropylene)glycol, poly(oxyethylene)glycol or copolymers thereof, it has a molecular weight of 1,000 to 6,000 and preferably in the range from 1,000 to 4,000.

Another preferred embodiment of the polyester/ether copolymer corresponding to formula (II) is made up of a central poly-THF block E and two hydroxyterminated polyester blocks formed by B, R³ and the hydroxyl group. In this case, B and R³ together may also represent the residue of a polycaprolactone, i.e. the reaction product here is a reaction product of a poly-THF with a polycaprolactone polymerized onto the hydroxyl groups at both ends. The poly-THF block may have a molecular weight in the range mentioned above while each polycaprolactone block may have a molecular weight in the range from 1,000 to 4,000. In that case, the polyester/polyether corresponding to formula (II) as a whole has a molecular weight of 2,000 to 8,000 and preferably in the range from 3,000 to 7,000. In this case, too, the polyether block may consist alternatively of a poly(oxypropylene)glycol, poly(oxyethylene)glycol or copolymers thereof. So far as the preferred molecular weight range is concerned, the foregoing observations apply.

The hydroxyl values of the polyester/polyether copolymer to be used are in the range from 5 to 40 and preferably in the range from 10 to 30. In the polyester/polyether copolymers of formula (I), the molar ratio between the polyether block and the polyester block is about 1:9, the polyether and polyester each making up about 50% by weight of the copolymers. The copolymer corresponding to formula (I) is preferably prepared by condensation of a corresponding carboxyl-terminated polyester with a polyether. In principle, however, the copolymer may also be prepared by condensation of the individual components polyether polyol, aliphatic dicarboxylic acid and dihydric alcohol in a single condensation step.

A number of aliphatic, cycloaliphatic or aromatic polyisocyanates may be used as the polyisocyanate.

Examples of suitable aromatic polyisocyanates are any isomers of toluene diisocyanate (TDI) either in the form of the pure isomers or as a mixture of several isomers, naphthalene-1,5-diisocyanate, diphenylmethane-4,4-diisocyanate (MDI), diphenylmethane-2,4′-diisocyanate and mixtures of 4,4′-phenylmethane diisocyanate with the 2,4′-isomer or mixtures thereof with oligomers of relatively high functionality (so-called crude MDI), xylylene diisocyanate (XDI), 4,4′-diphenyldimethyl methane diisocyanate, di- and tetraalkyl diphenylmethane diisocyanate, 4,4′-dibenzyl diisocyanate, 1,3-phenylenediisocyanate, 1,4-phenylene diisocyanate. Examples of suitable cycloaliphatic polyisocyanates are the hydrogenation products of the above-mentioned aromatic diisocyanates, such as for example 4,4′-dicyclohexylmethane diisocyanate (H₁₂MDI), 1-isocyanatomethyl-3-isocyanato-1,5,5-trimethylcyclohexane (isophorone diisocyanate, IPDI), cyclohexane-1,4-diisocyanate, hydrogenated xylylene diisocyanate (H₆XDI), 1-methyl-2,4-diisocyanatocyclohexane, m- or p-tetramethyl xylylene diisocyanate (m-TMXDI, p-TMXDI) and dimer fatty acid diisocyanate. Examples of aliphatic polyisocyanates are tetramethoxybutane-1,4-diisocyanate, butane-1,4-diisocyanate, hexane-1,6-diisocyanate (HDI), 1,6-diisocyanato-2,2,4-trimethylhexane, 1,6diisocyanato-2,4,4-trimethylhexane and 1,12-dodecane diisocyanate (C₁₂DI).

The polyurethane hotmelt adhesive compositions according to the invention may optionally contain other prepolymers in the form of reaction products of one of the above-mentioned polyisocyanates with a polyester polyol and/or optionally a reaction product of one of the above-mentioned polyisocyanates with a polyether polyol.

Examples of such polyester polyols are reaction products of dicarboxylic acids, such as glutaric acid, adipic acid, pimelic acid, suberic acid, azelaic acid, sebacic acid, undecanedioic acid, dodecanedioic acid, 3,3-dimethylglutaric acid, terephthalic acid, isophthalic acid, dimer fatty acid or mixtures thereof with low molecular weight dihydric alcohols, such as for example ethylene glycol, propylene glycol, 1,4-butanediol, 1,6-hexanediol, 1,8-octane diol, 1,10-decanediol, 1,12-dodecanediol, dimer fatty alcohol, diethylene glycol, triethylene glycol or mixtures thereof. The suitable polyesterpolyols may also be slightly branched, i.e. they are produced using small quantities of a tricarboxylic acid or a trihydric alcohol, for example glycerol or trimethylolpropane. Another group of polyester polyols suitable for use in accordance with the invention are polyesters based on ε-caprolactone, also known as “polycaprolactones”. However, polyester polyols of oleochemical origin may also be used. Oleochemical polyester polyols may be obtained, for example, by complete ring opening of epoxidized triglycerides of a fatty mixture containing at least partly olefinically unsaturated fatty acids with one or more alcohols containing 1 to 12 carbon atoms and subsequent partial transesterification of the triglyceride derivatives to form alkylester polyols containing 1 to 12 carbon atoms in the alkyl group. Other suitable polyols are polycarbonate polyols and dimer diols (Henkel) and also castor oil and derivatives thereof.

Examples of the polyether polyols to be used in accordance with the invention for the other prepolymers are di- and/or trifunctional polypropylene glycols with molecular weights in the range from 200 to 15,000 and preferably in the range from 400 to 4,000. Statistical and/or block copolymers of ethylene oxide and propylene oxide may also be used.

The reaction of the individual polyol structural elements corresponding to formula (I) or (II) or the other polyester polyol or polyether polyol with the polyisocyanate is carried out in known manner by reaction of a stoichiometric excess of polyisocyanate over the polyol compound. The stoichiometric ratio of OH groups to NCO groups is typically 1:1.2 to 1:15 and preferably 1:2 to 1:5.

To produce the isocyanate-terminated polyurethane prepolymers, it may be necessary to add polyurethane catalysts known per se such as, for example, compounds of di- or tetravalent tin, more particularly dicarboxylates of divalent tin or dialkyl tin dicarboxylates or dialkyl tin dialkoxylates.

In addition, it may be necessary to add catalysts to the hotmelt adhesive compositions in order to accelerate curing with ambient moisture. Particularly suitable catalysts are acyclic and, above all, cyclic amino compounds, for example tetramethyl butane diamine, bis(dimethylaminoethyl)ether, 1,4-diazabicyclooctane (DABCO), 1,8-diazabicyclo-(5.4.0)-undecene or morpholino derivatives. Examples of such morpholino derivatives are bis(2-(2,6-dimethyl-4-morpholino)ethyl)-(2-(4-morpholino) ethyl) amine, bis(2-(2,6-dimethyl-4-morpholino)ethyl)-(2-(2,6-diethyl-4-morpholino) ethyl) amine, tris(2-(4-morpholino) ethyl) amine, tris(2-(4-morpholino) propyl) amine, tris(2-(4-morpholino) butyl) amine, tris(2-(2,6-dimethyl-4-morpholino) ethyl) amine, tris(2-(2,6-diethyl-4-morpholino) ethyl) amine, tris(2-(2-methyl-4-morpholino) ethyl) amine or tris(2-(2-ethyl-4-morpholino) ethyl) amine, dimethyl aminopropyl morpholine, bis-(morpholinopropyl)-methylamine, diethylaminopropyl morpholine, bis-(morpholinopropyl)-ethylamine, bis-(morpholinopropyl)-propylamine, morpholinopropyl pyrrolidone or N-morpholinopropyl-N′-methyl piperazine, 2,2′-dimorpholinodiethyl ether (DMDEE) or di-2,6-dimethylmorpholinoethyl) ether.

The compositions according to the invention may also contain other additives typical of hotmelt adhesives, for example tackifying resins such as, for example, abietic acid, abietic acid esters, terpene resins, terpene-phenol resins or hydrocarbon resins. Fillers may also be used in small quantities, examples of suitable fillers being silicates, talcum, calcium carbonates, clays, carbon black or pigment pastes or pigments.

The choice of the individual components, more particularly the polyol components, is governed by the particular application envisaged and by the properties ultimately required. It has been found that the block structure of the polyester/ether copolymers corresponding to formula (I) or (II) provides for improved compatibility in relation to known poly-THF-based hotmelt adhesives which is reflected in the fact that the hotmelt adhesive compositions according to the invention are generally transparent (providing they do not contain any fillers, pigments or similar components). In addition, excellent creep resistance and interfacial adhesion values were observed and very high strength levels achieved with the compositions according to the invention.

The hotmelt adhesives according to the invention are suitable for bonding a number of substrates, more particularly metal substrates and above all various plastic substrates.

Examples of preferred applications for the hotmelt adhesives according to the invention include assembly bonding in the wood and furniture industry and the bonding of retainers in the automotive industry. In this particular field of application, the retainers of ABS are bonded to resin-bonded moldings of the type marketed, for example, under the name of “Empeflex” by the Empe company. Another field of application is the sheathing of profiles in the wood industry, furniture and window manufacture. In this field of application, PVC profiles are bonded over their entire surface to decorative PVC films.

The following Examples are intended to illustrate the invention. So far as the compositions are concerned, all quantities are in parts by weight unless otherwise indicated.

### EXAMPLES

Polyether/polyester polyols were produced from the synthesis components 1,6-hexanediol, 1,4-butanediol, poly-THF 2000, poly-THF 1000, adipic acid and/or dimethyl terephthalate and/or polypropylene glycol 1000 by a conventional condensation process until the hydroxyl values shown in Table 1 were reached. The molar ratios of the synthesis components and the percentage by weight (% by weight) of the polyether block are also shown in Table 1.

TABLE 1

| | Molar ratio | | | | | | | | |
|---|---|---|---|---|---|---|---|---|---|
| | Hexane- | Butane- | PTHF | PTHF | PPG | Adipic | Dimethyl- | | % Poly- |
| Example | diol | diol | 2000 | 1000 | 1000 | acid | terephthalate | OHV | ether |
| 1 | 15.1 | — | 1 | — | — | 14.9 | — | 23 | 37 |
| 2 | 11.6 | — | 1 | — | — | 11.2 | — | 34 | 43 5 |
| 3 | 11.6 | — | 1 | — | — | 11.2 | — | 28 | 43.5 |
| 4 | 9 | — | 1 | — | — | 9 | — | 25 | 50 |
| 5 | 9 | — | 1 | — | — | 9 | — | 14 | 50 |
| 6 | 7 | — | 1 | — | — | 7 | — | 25 | 55.5 |
| 7 | 2.1 | — | 1 | — | — | 2.4 | — | 17 | 80 |
| 8 | 2.1 | — | 1 | — | — | 2.4 | — | 11 | 80 |
| 9 | — | 10.2 | 1 | — | — | 9.9 | — | 27 | 50 |
| 10 | — | 10.2 | 1 | — | — | 9.9 | — | 23 | 50 |
| 11 | — | 1.7 | — | 1 | — | — | 2 | 48 | 71 |
| 12 | — | 1.7 | — | — | 1 | — | 2 | 42 | 71 |

Remarks
PTHF 2000: poly-THF, molecular weight 2,000
PTHF 1000: poly-THF, molecular weight 1,000
PPG 1000: polypropylene glycol, molecular weight 1,000
OHV: hydroxyl value (mg KOH to DIN 53240)
% polyether: % by weight of the polyether block in the polyether/ester

Hotmelt adhesive compositions were produced from the above-mentioned polyether/polyester polyols, commercially available polyester polyols based on dodecanedioic acid/1,6-hexanediol or adipic acid/1,6-hexanediol and 4,4′-diphenylmethane diisocyanate and were tested for some important properties, such as viscosity and creep resistance. For comparison, a hotmelt adhesive was produced from poly-THF 2000, a polyester of hexanediol adipate and a polyester of dodecanedioic acid/1,6-hexane diol and 4,4′-MDI. As can be seen from Table 2 below, the hotmelt adhesive compositions according to the invention have a considerably higher creep resistance compared with the prior art.

The creep resistance of a polyurethane (PUR) hotmelt is determined as follows:

Two overlapping substrates of different materials (wood/ABS) were bonded to one another. The wood test specimen is a beech plywood test specimen measuring 10×100 mm. The dimensions of the ABS test specimen were 25×100 mm. Commercially available ABS sheet (Bayer or Dow) was used. Using a template, an area of 10×10 mm was coated with the hotmelt adhesive to be tested. The two substrate parts were then immediately fitted together and pressed together with a test tube clip. The pressing time was 3 mins. Thereafter a weight was attached to the end of the wood part of the test specimen and the test specimen plus weight was vertically suspended from the other end. The weight at which the test specimen did not separate inside 30 minutes was determined.

TABLE 2

| | Example | | | | | | |
|---|---|---|---|---|---|---|---|
| Polyol | Comparison | 13 | 14 | 15 | 16 | 17 | 18 |
| PTHF2000 | 27 | | | | | | |
| HMA | 52 | 19 | 53 | 50 | 50 | 50 | 50 |
| HDDA | 8 | 8 | 8 | | | | |
| Polyetherester 5 | | 60 | | | | | |
| Polyetherester 10 | | | 60 | | | | |
| Polyetherester 11 | | | | 30 | 25 | | |
| Polyether ester 12 | | | | | | 25 | 17.5 |
| NCO-KZ with | 1.6 | 1.7 | 1.6 | 2 | 1.8 | 1.8 | 1.8 |
| MDI | | | | | | | |
| Viscosity at | 11 | 43 | 36 | 9.1 | 11.3 | 8.4 | 9.8 |
| 130° C. | | | | | | | |
| Creep test | 3 | 3.5 | 3.7 | 4 | 4 | 4 | 4 |
| [kg/cm²] | | | | | | | |

Remarks:
HMA polyhexamethylene adipate, OHV 30.5
HDDA polyesterol of dodecanedioic acid and 1,6-hexanediol, OHV 30
OHV hydroxyl value (mg KOH to DIN 53240)
PTHF2000: poly-THF, molecular weight 2,000
NCO-KZ NCO:OH ratio, isocyanate used: 4,4′-MDI
Viscosity in Pa · s, Brookfield Thermocell

1. A polyurethane hotmelt adhesive composition containing
a.) a reaction product of a polyisocyanate with a polyester/polyether copolymer corresponding to formula (I) or (II):
HO—R²—[—O-A-O—R¹—]ₙ—OH (I)
HO—R³—B-E-B—R³—OH (ii)
and
b.) optionally a reaction product of a polyisocyanate with a polyesterpolyol and/or
c.) optionally a reaction product of a polyisocyanate with a polyether polyol;
in formulae (I) and (II):
A stands for 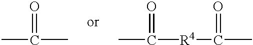
R¹ and R² independently of one another represent —(CH₂)ₘ—, (—(CH₂)₄—O—(CH₂)₄—)ₒ, (C₃H₆—O—C₃H₆—)ₒ, (—C₂H₄—O—C₂H₄—)ₚ or a combination thereof and
R³ represents —(CH₂)ₘ—, —(C₂H₄—O—C₂H₄)ₒ— or —(C₃H—I—C₃H₆)ₒ—,
B is the block of a carboxyl-terminated polyester or B and R³ together form the residue of a polycaprolactone,
E is the block of a poly(oxytetramethylene)glycol, poly(oxypropylene)glycol, poly(oxyethylene)glycol or copolymers thereof,
R⁴ is a C₁₋₁₂ alkyl group or a residue of a carboxyl-terminated polyester after removal of the carboxyl groups and
n=1 to 30, m=2 to 12, o=5 to 80 and p=5 to 80.

2. A hotmelt adhesive composition as claimed in claim 1, characterized in that the polyester/ether copolymer of formula (I) is essentially a block copolymer with the structure E-B-E where B is the block of a carboxyl-terminated polyester and E is the block of a poly(oxytetramethylene)glycol.

3. A hotmelt adhesive composition as claimed in claim 1, characterized in that the polyester/ether copolymer of formula (I) is essentially a block copolymer with the structure E-B-E where B is the block of a carboxyl-terminated polyester and E is the block of a poly(oxypropylene)glycol, poly(oxyethylene)glycol or copolymers thereof.

4. A composition as claimed in claim 2 or 3, characterized in that the carboxyl-terminated polyester block B is synthesized from aliphatic or aromatic dicarboxylic acids selected from adipic acid, pimelic acid, suberic acid, azelaic acid, sebacic acid, undecanedioic acid, dodecanedioic acid, phthalic acid, terephthalic acid, isophthalic acid or mixtures thereof and dihydric alcohols selected from ethylene glycol, propylene glycol, butanediol, diethylene glycol, triethylene glycol, dipropylene glycol, tripropylene glycol, hexanediol, octanediol, decanediol, dodecanediol or mixtures thereof.

5. A composition as claimed in claim 4, characterized in that the polyester block has a molecular weight of 600 to 10,000 and preferably in the range from 1,000 to 6,000.

6. A composition as claimed in claims 2 to 5, characterized in that the block E of the polyether has a molecular weight of 200 to 15,000 and preferably in the range from 600 to 4,000.

7. A composition as claimed in at least one of the preceding claims, characterized in that the polyesterpolyol of component b) is synthesized from aliphatic dicarboxylic acids selected from adipic acid, pimelic acid, suberic acid, azelaic acid, sebacic acid, undecanedioic acid, dodecanedioic acid, dimer acid, 3,3-dimethylglutaric acid, aromatic dicarboxylic acids selected from terephthalic acid, isophthalic acid, naphthalenedicarboxylic acid or mixtures and dihydric alcohols selected from ethylene glycol, propylene glycol, butanediol, diethylene glycol, triethylene glycol, dipropylene glycol, tripropylene glycol, hexanediol, octanediol, decanediol, dodecanediol, neopentyl glycol, dimer diol, hydroxypivalic acid neopentyl glycol or mixtures thereof.

8. A composition as claimed in at least one of the preceding claims, characterized in that component c.) is a polypropylene glycol, polyethylene glycol, copolymer of ethylene oxide and propylene oxide or a poly(oxytetramethylene)glycol.

9. A composition as claimed in at least one of the preceding claims, characterized in that it contains
5 to 100% by weight of component a.),
0 to 80% by weight of component b.) and
0 to 80% by weight of component c.).
